(19) United States
(12) Patent Application Publication
(10) Pub. No.: US 2015/0218393 A1
(43) Pub. Date: Aug. 6, 2015

(54) STABLE UV ABSORBER COMPOSITION

(71) Applicant: BASF SE, Ludwigshafen (DE)

(72) Inventors: Daniel Rogez, Mulhouse (FR); Silke Fischer, Weisenheim am Sand (DE); Axel Becker, Altrip (DE); Delphine Kimpel, Speyer (DE)

(73) Assignee: BASF SE, Ludwigshafen (DE)

(21) Appl. No.: 14/421,492

(22) PCT Filed: Aug. 9, 2013
(86) PCT No.: PCT/EP2013/066715

§ 371 Date: Feb. 13, 2015

Related U.S. Application Data
(60) Provisional application No. 61/683,742, filed on Aug. 16, 2012.

(30) Foreign Application Priority Data
Aug. 16, 2012 (EP) 12180606.1

(51) Int. Cl. C09D 5/32; B05D 3/06

(52) U.S. Cl. CPC C09D 5/32; B05D 3/067

(57) ABSTRACT

The invention relates to a novel stabilizer mixture comprising certain UV absorbers and specific (meth)acrylates, which are stable during storage and which are easily miscible with radiation curable coatings.

The invention relates to a novel stabilizer mixture comprising certain UV absorbers and specific (meth)acrylates, which are stable during storage, which are easily miscible with radiation curable coatings, and which are designed to provide coating light stabilization and colour protection to coated substrates, especially wood and wood based materials.

UV absorbers are commonly admixed to radiation curable coatings are widely known to stabilize this mixture and the underlying substrates against damage by light, heat and oxygen.

However, it is often wanted to store UV absorbers in stock solutions with radiation curable compounds in order to easily admix these stock solutions into coating compositions. Such stock solutions are often unstable and tend to phase separation during storage.

Furthermore, certain types of UV absorbers are not suitable for radiation curable coatings, since they reduce the yield of radical formation.

It was an object of the present invention to develop stable stock solutions of UV absorbers in (meth)acrylates and radiation curable coatings especially designed for the photoprotection of wood and wood based materials comprising such stock solutions stabilized against degradation induced by UV light, heat and/or oxidation.

Thus, subject of the invention is a composition consisting of

(Z) at least one compound of the formula

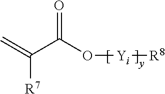

wherein,
R⁷ is selected from the group consisting of hydrogen and methyl,
R⁸ is C₁-C₂₀ alkyl,
Y is a positive integer from 1 to 90, preferably 2 to 50, more preferably from 4 to 40, especially preferably from 8 to 25, and most preferably from 10 to 20, and
   each Yᵢ for i=1 to y may be selected independently of the others from the group consisting of —CH₂—CH₂—O—, —CH₂—CH(CH₃)—O—, —CH(CH₃)—CH₂—O—, —CH₂—C(CH₃)₂—O—, —C(CH₃)₂—CH₂—O—, —CH₂—CHVin-O—, —CHVin-CH₂—O—, —CH₂—CHPh-O—, and —CHPh-CH₂—O—, preferably from the group —CH₂—CH₂—O—, —CH₂—CH(CH₃)—O—, and —CH(CH₃)—CH₂—O—, and more preferably —CH₂—CH₂—O—, in which Ph is phenyl and Vin is vinyl,
   and at least one UV absorber selected from the group consisting of (4-phenyl) phenyl triazines (A), benzotriazoles (B), 2-hydroxyphenyl triazines, hydroxybenzophenones (D), and 3,3-diaryl-2-cyano propenoates (E), preferably selected from the group consisting of (4-phenyl) phenyl triazines (A) and benzotriazoles (B) and more preferably benzotriazoles (B), and optionally at least one solvent (F).

In these definitions, C₁-C₂₀ alkyl is for example methyl, ethyl, propyl, isopropyl, n-butyl, sec-butyl, tert-butyl, pentyl, hexyl, heptyl, octyl, 2-ethylhexyl, 2,4,4-trimethylpentyl, decyl, dodecyl, tetradecyl, hexadecyl, octadecyl, 1,1-dimethylpropyl, 1,1-dimethylbutyl, 1,1,3,3-tetramethylbutyl, preferably methyl, ethyl or n-propyl, very preferably methyl or ethyl and especially preferably methyl.

Examples of R⁶ are methyl, ethyl, n-propyl, isopropyl, n-butyl, sec-butyl, tert-butyl, octyl, 2-ethylhexyl, dodecyl, tetradecyl, hexadecyl and octadecyl, preferably R⁶ is selected from the group consisting of methyl, ethyl, n-propyl, isopropyl and n-butyl, more preferably methyl or n-butyl and especially preferably methyl.

Preferred components (Z) are (meth)acrylic acid esters of monofunctional, alkyl-capped polyethylene glycols with an average molecular mass from 100 to 4000 g/mol, preferably from 500 to 2000 and more preferably from 500 to 1000. Particular preference is given to C₁-C₄-alkyl groups.

C₁-C₄ alkyl in the context of this specification denotes methyl, ethyl, isopropyl, n-propyl, n-butyl, isobutyl, sec-butyl, and tert-butyl, preferably methyl, ethyl, and n-butyl, more preferably methyl and ethyl, and very preferably methyl.

Very particular preference is given to methyl-capped polyethylene glycols.

UV absorbers of the above-mentioned types are:

(A) a compound of the formula I

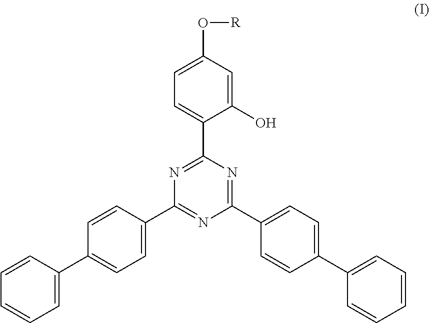

wherein R is (CH₂—CH₂—O—)ₙ—R₂; —CH₂—CH(OH)—CH₂—O—R₂; or —CH(R₃)—CO—O—R₄; n is 0 or 1; R₂ is C₁-C₁₃alkyl or C₂-C₂₀alkenyl or C₆-C₁₂aryl or CO—C₁-C₁₈alkyl; R₃ is H or C₁-C₈alkyl; R₄ is C₁-C₁₂alkyl or C₂-C₁₂alkenyl or C₅-C₆cycloalkyl; and
   (B) a compound selected from benzotriazoles the formula (B),

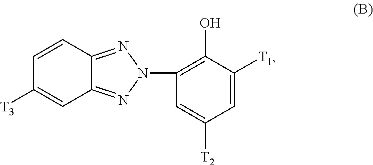

wherein T₁ is hydrogen, C₁-C₁₈alkyl, or C₁-C₁₈alkyl which is substituted by phenyl,
or T₁ is a group of the formula

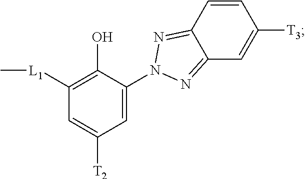

L₁ is a divalent group, for example —(CH₂)ₙ—, where n is from the range 1-8;
T₂ is hydrogen, C₁-C₁₈alkyl, or is C₁-C₁₈alkyl which is substituted by COOT₅, C₁-C₁₈alkoxy, hydroxyl, phenyl or C₂-C₁₈acyloxy;
T₃ is hydrogen, halogen, C₁-C₁₈alkyl, C₁-C₁₈alkoxy, C₂-C₁₈acyloxy, perfluoroalkyl of 1 to 12 carbon atoms such as —CF₃, or T₃ is phenyl;
T₅ is C₁-C₁₈alkyl or C₄-C₅₀alkyl interrupted by one or more O and/or substituted by OH or by a group

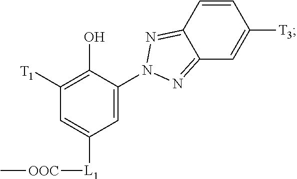

(C) a compound selected from 2-hydroxyphenyltriazines of formula (C),

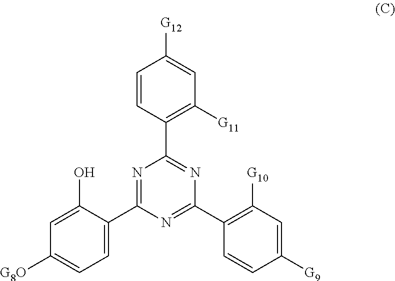

wherein
G₈ is C₁-C₁₈alkyl, or is C₄-C₁₈alkyl which is interrupted by COO or OCO or O, or is interrupted by O and substituted by OH;
G₉, G₁₀, G₁₁ and G₁₂ independently are hydrogen, methyl, hydroxy or OG₈; and
(D) a compound selected from 2-hydroxybenzophenones of the formula (D)

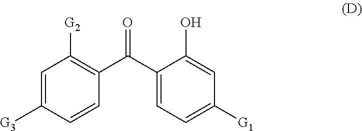

wherein
G₁, G₂ and G₃ independently are hydrogen, hydroxy or C₁-C₁₈alkoxy; and
(E) a compound selected from 3,3-diaryl-2-cyano propenoates of the formula (E)

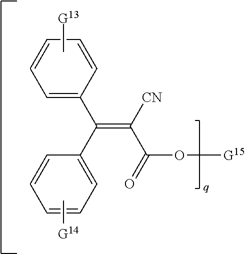

wherein
q is a positive integer from 1 to 4
G¹³ and G¹⁴, independently are hydrogen, hydroxy, C₁-C₁₈ alkyl or C₁-C₁₈ alkoxy and
G¹⁵ is a q-valent hydrocarbon with 1 to 10 carbon atoms, preferably a q-valent aliphatic hydrocarbon with 2 to 8 carbon atoms.

Preferably, components (B) to (E) are selected from the group consisting of one or more compounds selected from (i) to (xxxvii):
i. 2-(3′,5′-di-tert-butyl-2′-hydroxyphenyl)-5-chlorobenzotriazole,
ii. 2-(3′,5′-di-tert-amyl-2′-hydroxyphenyl)benzotriazole,
iii. 2-(3′,5′-bis(α,α-dimethylbenzyl)-2′-hydroxyphenyl)benzotriazole,
iv. 2-(3′-tert-butyl-2′-hydroxy-5′-(2-octyloxycarbonylethyl)phenyl)benzotriazole,
v. 2,2′-methylene-bis[4-(1,1,3,3-tetramethylbutyl)-6-benzotriazole-2-ylphenol],
vi. the transesterification product of 2-[3′-tert-butyl-5′-(2-methoxycarbonylethyl)-2′-hydroxyphenyl]-2H-benzotriazole with polyethylene glycol 300,
vii. 2-[2′-hydroxy-3′-(α,α-dimethylbenzyl)-5′-(1,1,3,3-tetramethylbutyl)phenyl]benzotriazole,
viii. 5-trifluoromethyl-2-(2-hydroxy-3-α-cumyl-5-tert-octylphenyl)-2H-benzotriazole,
ix. 2-(2′-hydroxy-5′-(2-hydroxyethyl)phenyl)benzotriazole,
x. 2-(2′-hydroxy-5′-(2-methacryloyloxyethyl)phenyl)benzotriazole,
xi. 2,4-bis(2,4-dimethylphenyl)-6-(2-hydroxy-4-alkyloxyphenyl)-1,3,5-triazine, where alkyl is a mixture of C₈-alkyl groups (CAS Nos. 137759-38-7; 85099-51-0; 85099-50-9);
xii. 2,4-bis(2,4-dimethylphenyl)-6-(2-hydroxy-4-octyloxyphenyl)-1,3,5-triazine (CAS No. 2725-22-6),
xiii. 2,4-diphenyl-6-(2-hydroxy-4-[α-ethylhexanoyloxyethyl]phenyl)-1,3,5-triazine,
xiv. 2,4-bis(2-hydroxy-4-butyloxyphenyl)-6-(2,4-bis-butyloxyphenyl)-1,3,5-triazine,
xv. 2,4,6-tris(2-hydroxy-4-[1-ethoxycarbonylethoxy]phenyl)-1,3,5-triazine,
xvi. the reaction product of tris(2,4-dihydroxyphenyl)-1,3,5-triazine with the mixture of α-chloropropionic esters (made from isomer mixture of C₇-C₉alcohols),
xvii. 2-[4-(dodecyloxy/tridecyloxy-2-hydroxypropoxy)-2-hydroxyphenyl]-4,6-bis(2,4-dimethylphenyl)1,3,5-triazine,
xviii. 2-{2-hydroxy-4-[3-(2-ethylhexyl-1-oxy)-2-hydroxypropyloxy]phenyl}-4,6-bis(2,4-dimethylphenyl)-1,3,5-triazine,
xix. 2-(2-hydroxy-4-hexyloxyphenyl)-4,6-diphenyl-1,3,5-triazine,
xx. 2-(3′-tert.butyl-5′-methyl-2′-hydroxyphenyl)-5-chloro-benzotriazole,
xxi. 2-(3′-sec. butyl-5′-tert.butyl-2′-hydroxyphenyl)-benzotriazole,
xxii. 2-(3′,5′-di-tert-butyl-2′-hydroxyphenyl)-benzotriazole,
xxiii. 2-(5′-tert.octyl-2′-hydroxyphenyl)-benzotriazole,
xxiv. 2-(3′-dodecyl-5′-methyl-2′-hydroxyphenyl)-benzotriazole,
xxv. 2-(3′-tert.butyl-5′-(2-octyloxycarbonylethyl)-2′-hydroxyphenyl)-5-chloro-benzotriazole,
xxvi. 2-(5′-methyl-2′-hydroxyphenyl)-benzotriazole,
xxvii. 2-(5′-tert.butyl-2′-hydroxyphenyl)-benzotriazole,
xxx. the compound of formula

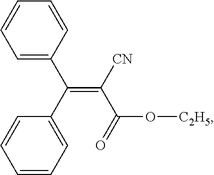 [SMILES: CCOC(=O)C(C#N)=C(c1ccccc1)c1ccccc1]

xxxi. the compound of formula

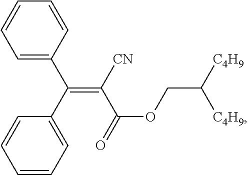

xxxii. 2,4-dihydroxybenzophenone,
xxxiii. 2-hydroxy-4-methoxybenzophenone,
xxxiv. 2-hydroxy-4-dodecyloxybenzophenone,
xxxv. 2-hydroxy-4-octyloxybenzophenone,
xxxvi. 2,2′-dihydroxy-4-methoxybenzophenone,
xxxvii. the compound of formula

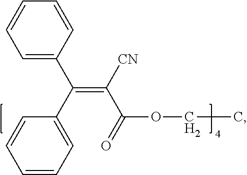

In the context of the definitions given, including R₂, R₃, R₄, or R⁶ alkyl is, for example, branched or unbranched alkyl such as methyl, ethyl, propyl, isopropyl, n-butyl, sec-butyl, isobutyl, t-butyl, 2-ethylbutyl, n-pentyl, isopentyl, 1-methylpentyl, 1,3-dimethylbutyl, n-hexyl, 1-methylhexyl, n-heptyl, isoheptyl, 1,1,3,3-tetramethylbutyl, 1-methylheptyl, 3-methylheptyl, n-octyl, 2-ethylhexyl, 1,1,3-trimethylhexyl, 1,1,3,3-tetramethylpentyl, nonyl, decyl, undecyl, 1-methylundecyl, dodecyl, 1,1,3,3,5,5-hexamethylhexyl, tridecyl, tetradecyl, pentadecyl, hexadecyl, heptadecyl, octadecyl.

Alkyl interrupted by more than one O is, for example, polyoxyalkylene such as a polyethylene glycol residue.

Aryl is in general an aromatic hydrocarbon radical, for example phenyl, biphenylyl or naphthyl.

Within the context of the definitions indicated alkenyl comprises, inter alia, vinyl, allyl, isopropenyl, 2-butenyl, 3-butenyl, isobutenyl, n-penta-2,4-dienyl, 3-methyl-but-2-enyl, n-oct-2-enyl, n-dodec-2-enyl, iso-dodecenyl, n-dodec-2-enyl, n-octadec-4-enyl.

Halogen is mainly fluoro, chloro, bromo or iodo, especially chloro.

C₅-C₆cycloalkyl mainly is cyclopentyl, cyclohexyl.

C₂-C₁₈acyloxy is, for example, alkanoyloxy, benzoyloxy, or alkenoyloxy such as acryloyloxy or methacryloyloxy.

An example for the divalent C₂-C₁₂alkane-dioxycarbonyl is —COO—CH₂CH₂—OCO—;

an example for the trivalent C₃-C₁₂alkane-trioxycarbonyl is —COO—CH₂—CH(OCO—)CH₂—OCO—;
an example for the tetravalent C₄-C₁₂alkane-tetraoxycarbonyl is (—COO—CH₂)₄C.

Each of components (A) to (D) may be a single compound or a mixture of compounds. In compound xvii, the dodecyl/tridecyl residue usually is a mixture of isomers. In compounds iv and xxv, the octyl residue is a mixture mainly of n-octyl and 2-ethylhexyl.

In a preferred embodiment, component (A) is selected from the compounds of formula (I), wherein R is C₁-C₁₃alkyl or —CH(R₃)—CO—O—R₄ with R₃ and R₄ independently are H or C₁-C₈alkyl;
(A1) 2-{2-hydroxy-4-[1-octyloxycarbonylethoxy]phenyl}-4,6-bis(4-phenylphenyl)-1,3,5-triazine and/or
(A2) 2-(2-hydroxy-4-(2-ethylhexyl)oxy)phenyl-4,6-bis(4-phenyl)phenyl-1,3,5-triazine of the formula

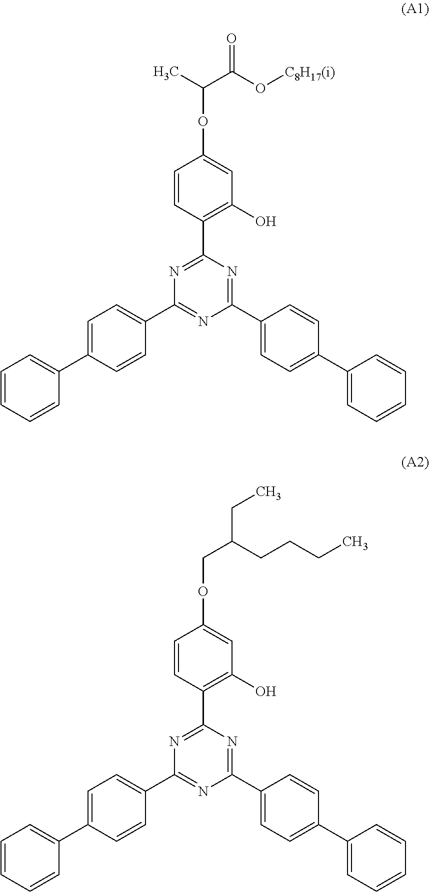

In formula (A1), the moiety C₈H₁₇ (i) usually is an isomer mixture of branched and unbranched octyl groups (see example A14 of U.S. Pat. No. 6,060,543).

In another preferred embodiment, components (B) to (E) are selected from the compounds i-xxxvii.

In a specific embodiment, component (A) is selected from compounds whose residue R contains an uninterrupted, branched or unbranched C₇-C₁₃alkyl chain.

Of specific technical interest is a composition wherein

component (A) is the compound (A1) and components (B) to (E) are selected from the compounds i-iv, vi-xi, xiii-xviii, xx, xxiii-xxxix; especially ii, iii, iv, vi, vii, viii, xx, xxv, xxxvii; in particular those of the benzotriazole class
or wherein
component (A) is the compound (A2) and components (B) to (E) are selected from the compounds i-x, xii, xiii, xix-xxiii, xxv-xxvii, xxx-xxxvi, and xl-xlv; especially i, ii, iii, v, vi, viii, xii, xiii, xix, xx, xxii, xxiii, xxvi, xxx, xxxi, xxxiv, xxxvi, xl, xli, xlii, xliii, xliv, xlv.

Each of components (A) to (E) may be a single compound or a mixture of compounds.

Compounds of component (A) are known e.g. from U.S. Pat. No. 5,959,008 and U.S. Pat. No. 6,255,483. Compounds of components (B) to (E) are known, e.g. compound xvi disclosed in WO 01/47900, example 4.

Further preferred compounds of component (A) are of the formulae

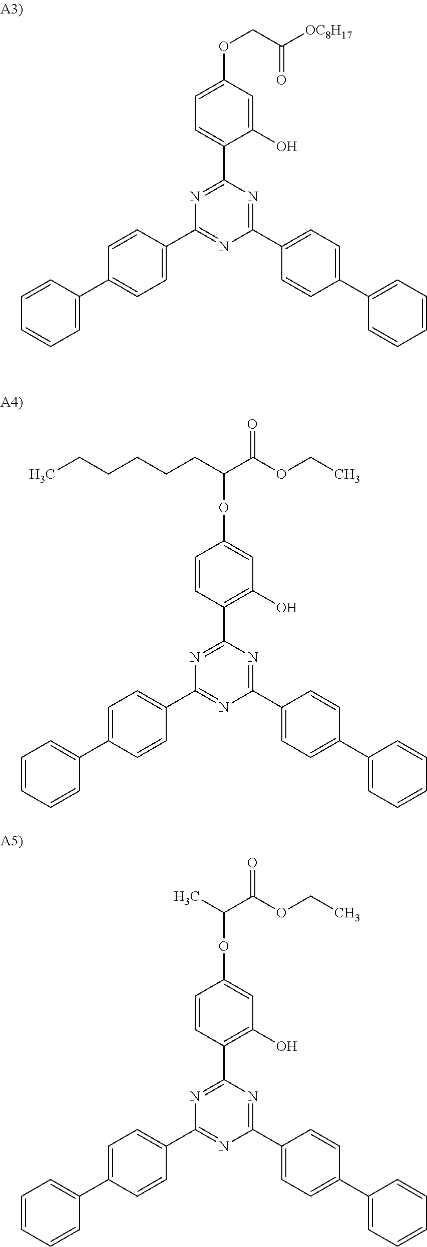

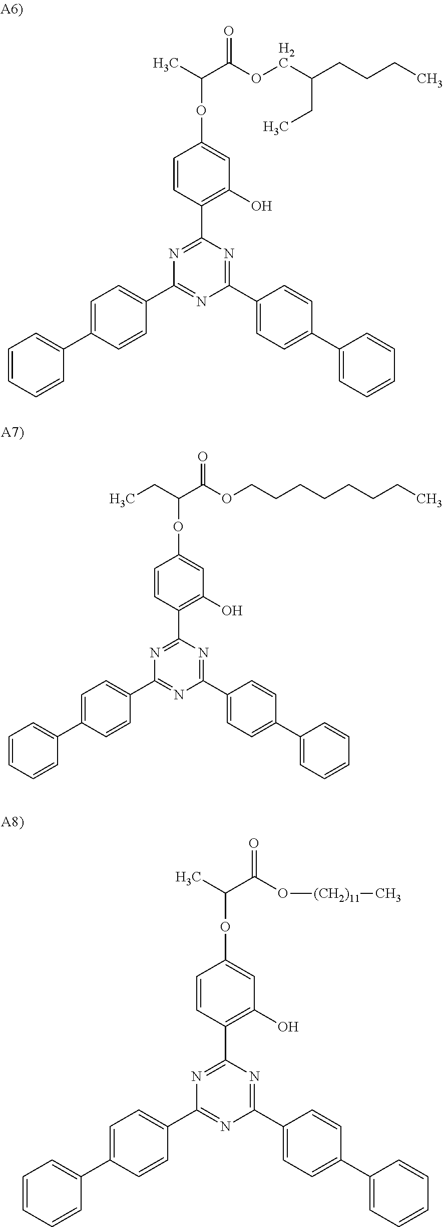

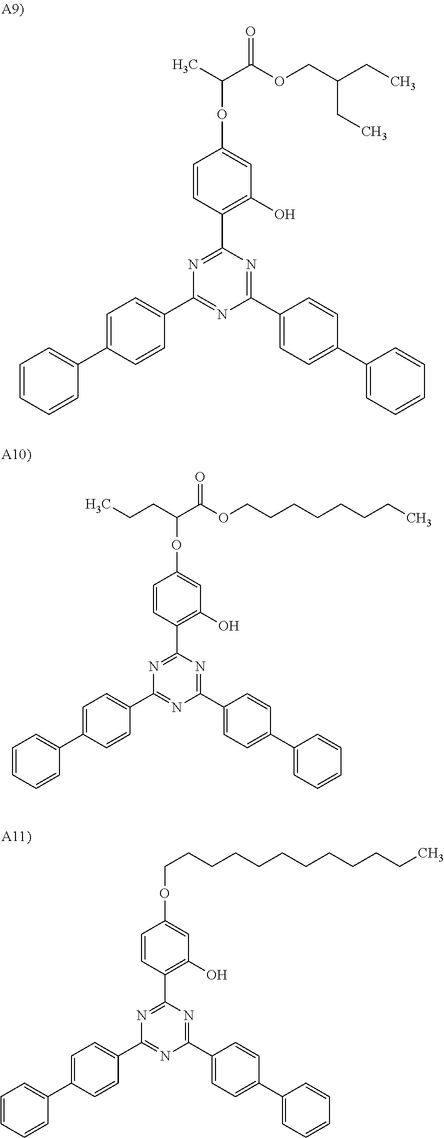 [SMILES: CCC(CC)COC(=O)C(C)Oc1ccc(-c2nc(-c3ccc(-c4ccccc4)cc3)nc(-c3ccc(-c4ccccc4)cc3)n2)c(O)c1 ; CCCCCCCCOC(=O)C(CCC)Oc1ccc(-c2nc(-c3ccc(-c4ccccc4)cc3)nc(-c3ccc(-c4ccccc4)cc3)n2)c(O)c1 ; CCCCCCCCCCCCOc1ccc(-c2nc(-c3ccc(-c4ccccc4)cc3)nc(-c3ccc(-c4ccccc4)cc3)n2)c(O)c1]

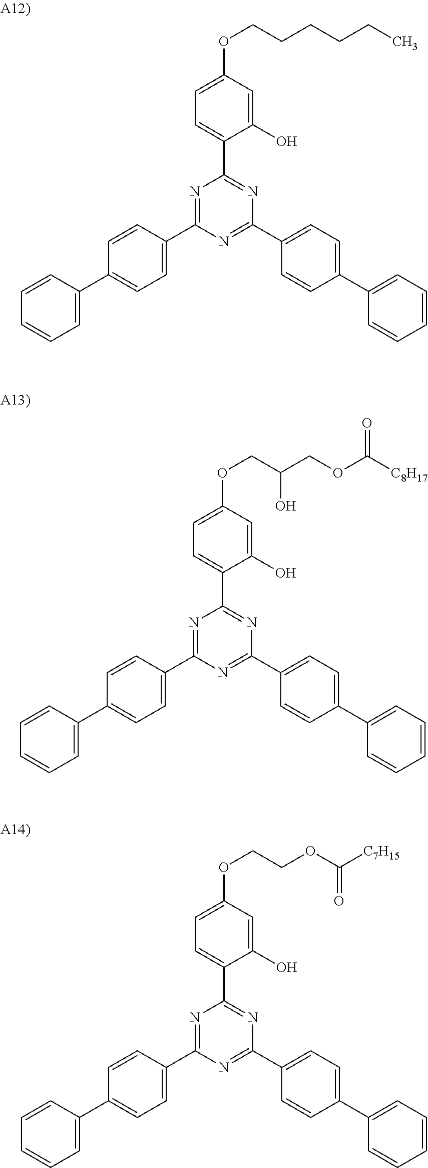

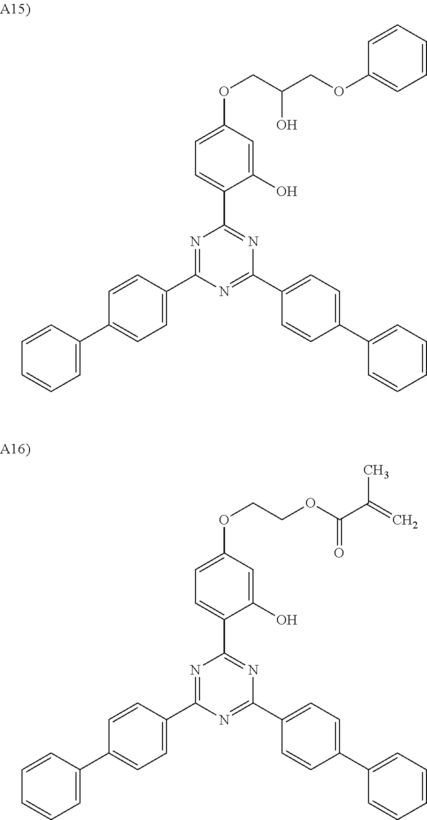 [SMILES: Oc1cc(OCC(O)COc2ccccc2)ccc1-c1nc(-c2ccc(-c3ccccc3)cc2)nc(-c2ccc(-c3ccccc3)cc2)n1 ; C=C(C)C(=O)OCCOc1ccc(-c2nc(-c3ccc(-c4ccccc4)cc3)nc(-c3ccc(-c4ccccc4)cc3)n2)c(O)c1]

Further preferred 2-(2′-Hydroxyphenyl)benzotriazoles (B) are for example 2-(2′-hydroxy-5′-(1,1,3,3-tetramethylbutyl)phenyl)benzotriazole, 2-(2′-hydroxy-4′-octyloxyphenyl)benzotriazole, 2-(3′-tert-butyl-2′-hydroxy-5′-(2-octyloxycarbonylethyl)phenyl)-5-chlorobenzotriazole, 2-(3′-tert-butyl-5′-[2-(2-ethylhexyloxyl)carbonylethyl]-2′-hydroxyphenyl)-5-chlorobenzotriazole, 2-(3′-tert-butyl-2′-hydroxy-5′-(2-methoxycarbonylethyl)phenyl)-5-chlorobenzotriazole, 2-(3′-tert-butyl-2′-hydroxy-5′-(2-methoxycarbonylethyl)phenyl)benzotriazole, 2-(3′-tert-butyl-2′-hydroxy-5′-(2-octyl-oxycarbonylethyl)phenyl)benzotriazole, 2-(3′-tert-butyl-5′-[2-(2-ethylhexyloxyl)carbonylethyl]-2′-hydroxyphenyl)benzotriazole, 2-(3′-dodecyl-2′-hydroxy-5′-methylphenyl)benzotriazole, 2-(3′-tert-butyl-2′-hydroxy-5′-(2-isooctyloxycarbonylethyl)phenylbenzotriazole, 2,2′-methylenebis[4-(1,1,3,3-tetramethylbutyl)-6-benzotriazole-2-ylphenol]; the transesterification product of 2-[3′-tert-butyl-5′-(2-methoxycarbonylethyl)-2′-hydroxyphenyl]-2H-benzotriazole with polyethylene glycol 300; [R—CH₂CHCOO—CH₂CH₂₂, where R=3′-tert-butyl-4′-hydroxy-5′-2H-benzotriazol-2-ylphenyl, 2-[2′-hydroxy-3′-(α,α-dimethylbenzyl)-5′-(1,1,3,3-tetramethylbutyl)phenyl]benzotriazole; 242′-hydroxy-3′-(1,1,3,3-tetramethylbutyl)-5′-(α,α-dimethylbenzyl)phenyl]benzotriazole.

Further preferred 2-(2-Hydroxyphenyl)-1,3,5-triazines (C) are for example 2,4,6-tris(2-hydroxy-4-octyloxyphenyl)-1,3,5-triazine, 2-(2,4-dihydroxyphenyl)-4,6-bis(2,4-dimethylphenyl)-1,3,5-triazine, 2,4-bis(2-hydroxy-4-propyloxyphenyl)-6-(2,4-dimethylphenyl)-1,3,5-triazine, 2-(2-hydroxy-4-octyloxyphenyl)-4,6-bis(4-methylphenyl)-1,3,5-triazine, 2-(2-hydroxy-4-dodecyloxyphenyl)-4,6-bis(2,4-dimethylphenyl)-1,3,5-triazine, 2-(2-hydroxy-4-tridecyloxyphenyl)-4,6-bis(2,4-dimethylphenyl)-1,3,5-triazine, 2-[2-hydroxy-4-(2-hydroxy-3-butyloxypropoxy)phenyl]-4,6-bis(2,4-dimethyl)-1,3,5-triazine, 2-[2-hydroxy-4-(2-hydroxy-3-octyloxypropyloxy)phenyl]-4,6-bis(2,4-dimethyl)-1,3,5-triazine, 2-[2-hydroxy-4-(2-hydroxy-3-dodecyloxypropoxy)phenyl]-4,6-bis(2,4-dimethylphenyl)-1,3,5-triazine, 2-(2-hydroxy-4-methoxyphenyl)-4,6-diphenyl-1,3,5-triazine, 2,4,6-tris[2-hydroxy-4-(3-butoxy-2-hydroxypropoxy)phenyl]-1,3,5-triazine, 2-(2-hydroxyphenyl)-4-(4-methoxyphenyl)-6-phenyl-1,3,5-triazine, 2-{2-hydroxy-4-[3-(2-ethylhexyl-1-oxy)-2-hydroxypropyloxy]phenyl}-4,6-bis(2,4-dimethylphenyl)-1,3,5-triazine.

Further potential Triazine compounds (C) are for example 2,4-bis(octylmercapto)-6-(3,5-di-tert-butyl-4-hydroxyanilino)-1,3,5-triazine, 2-octylmercapto-4,6-bis(3,5-di-tert-butyl-4-hydroxyanilino)-1,3,5-triazine, 2-octylmercapto-4,6-bis(3,5-di-tert-butyl-4-hydroxyphenoxy)-1,3,5-triazine, 2,4,6-tris(3,5-di-tert-butyl-4-hydroxyphenoxy)-1,2,3-triazine, 1,3,5-tris(3,5-di-tert-butyl-4-hydroxyben-zyl)isocyanurate, 1,3,5-tris(4-tert-butyl-3-hydroxy-2,6-dimethylbenzyl)isocyanurate, 2,4,6-tris-(3,5-di-tert-butyl-4-hydroxyphenylethyl)-1,3,5-triazine, 1,3,5-tris(3,5-di-tert-butyl-4-hydroxy-phenylpropionyl)-hexahydro-1,3,5-triazine, 1,3,5-tris(3,5-dicyclohexyl-4-hydroxybenzyl)isocyanurate.

Further preferred 2-Hydroxybenzophenones (D) are for example the 4-decyloxy, 4-benzyloxy, 4,2′,4′-trihydroxy and 2′-hydroxy-4,4′-dimethoxy derivatives.

Preferred compounds (E) are those in which G¹³ and G¹⁴ each are hydrogen and G¹⁵ is C₁ to C₁₈ alkyl, especially preferably G¹⁵ is selected from the group consisting of methyl, ethyl, propyl, isopropyl, n-butyl, sec-butyl, isobutyl, t-butyl, 2-ethylbutyl, n-pentyl, isopentyl, 1-methylpentyl, 1,3-dimethylbutyl, n-hexyl, 1-methylhexyl, n-heptyl, isoheptyl, 1,1,3,3-tetramethylbutyl, 1-methylheptyl, 3-methylheptyl, n-octyl, 2-ethylhexyl, 1,1,3-trimethylhexyl, 1,1,3,3-tetramethylpentyl, nonyl, decyl, undecyl, 1-methylundecyl and dodecyl, and very preferably compounds (E) are selected from the group consisting of compounds xxx, xxxi and xxxvii.

The composition according to the invention is generally as follows:

(Z) 1% to 50%, preferably 5% to 40%, and more particularly 10% to 30%, by weight
components (A) to (E) 50% to 99%, preferably 60% to 95%, and more particularly 70% to 90%, by weight
with the proviso that the sum always amounts to 100% by weight.

The composition may further optionally comprise at least one solvent (F).

Preferred solvents (F) are water, alkanols, acetone, isobutyl methyl ketone, toluene, xylene, butyl acetate, methoxypropyl acetate or ethoxyethyl acetate.

Very preferred solvents (F) are water, ethanol, n-propanol, iso-propanol, n-butanol, sek-butanol, iso-butanol, n-hexanol, 2-ethyl hexanol, ethylene glycol, and poly ethylene glycols with a molecular mass of from 102 to 238.

The optional solvent (F) may be present in amounts of 0 to 300% by weight based on the weight of components (A) to (E) and (Z) in sum, preferably in amounts of 10 to 200%, very preferably 20 to 150% and especially preferably in amounts of 30 to 100% by weight.

Another subject of the present invention is a radiation-curable coating composition, comprising
(Z) at least one compound of the formula

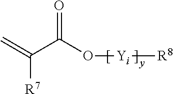

wherein,
R⁷ is selected from the group consisting of hydrogen and methyl,
R⁸ is C₁-C₂₀ alkyl,
n is a positive integer from 1 to 90, preferably 2 to 50, more preferably from 4 to 40, especially preferably from 8 to 25, and most preferably from 10 to 20, and
each Yi for i=1 to y may be selected independently of the others from the group consisting of —CH₂—CH₂—O—, —CH₂—CH(CH₃)—O—, —CH(CH₃)—CH₂—O—, —CH₂—C(CH₃)₂—O—, —C(CH₃)₂—CH₂—O—, —CH₂—CHVin-O—, —CHVin-CH₂—O—, —CH₂—CHPh-O—, and —CHPh-CH₂—O—, preferably from the group —CH₂—CH₂—O—, —CH₂—CH(CH₃)—O—, and —CH(CH₃)—CH₂—O—, and more preferably —CH₂—CH₂—O—,
in which Ph is phenyl and Vin is vinyl,
   at least one UV absorber selected from the group consisting of (4-phenyl) phenyl triazines (A), benzotriazoles (B), 2-hydroxyphenyl triazines (C), hydroxybenzophenones (D), and 3,3-diary)-2-cyano propenoates (E), preferably selected from the group consisting of (4-phenyl) phenyl triazines (A) and benzotriazoles (B) and more preferably benzotriazoles (B),
   at least one polyfunctional polymerizable compound (Y) having more than one, preferably having at least two (meth)acrylate groups, and
   optionally at least one photoinitiator(X).

Polyfunctional polymerizable compounds (Y) are preferably polyfunctional (meth)acrylates which carry at least two, preferably 2-10, more preferably 2-6, very preferably 2-4, and more particularly 2-3 (meth)acrylate groups, preferably acrylate groups.

Polyfunctional polymerizable compounds (Y) are preferably selected from the group consisting of esters of (meth)acrylic acid with polyalcohols, urethane (meth)acrylates, epoxy (meth)acrylates, and polyester (meth)acrylates, preferably urethane (meth)acrylates.

Polyalcohols of this kind are suitably, for example, at least dihydric polyols, polyetherols or polyesterols, or polyacrylate polyols, having an average OH functionality of at least 2, preferably 3 to 10.

Examples of polyfunctional polymerizable compounds are ethylene glycol diacrylate, 1,2-propanediol diacrylate, 1,3-propanediol diacrylate, 1,4-butanediol diacrylate, 1,3-butanediol diacrylate, 1,5-pentanediol diacrylate, 1,6-hexanediol diacrylate, 1,8-octanediol diacrylate, neopentyl glycol diacrylate, 1,1-, 1,2-, 1,3-, and 1,4-cyclohexanedimethanol diacrylate, 1,2-, 1,3- or 1,4-cy-clohexanediol diacrylate, trimethylolpropane triacrylate, ditrimethylolpropane pentaacrylate or hexaacrylate, pentaerythritol triacrylate or tetraacrylate, glycerol diacrylate or triacrylate, and also diacrylates and polyacrylates of sugar alcohols, such as of sorbitol, mannitol, diglycerol, threitol, erythritol, adonitol (ribitol), arabitol (lyxitol), xylitol, dulcitol (galactitol), maltitol or isomalt, for example, or of polyesterpolyols, polyetherols, poly-1,3-propanediol having a molar mass between 134 and 1178, polyethylene glycol having a molar mass between 106 and 898, and also epoxy (meth)acrylates, urethane (meth)acrylates or polycarbonate (meth)acrylates.

Further examples are (meth)acrylates of compounds of the formulae (IIIa) to (IIId),

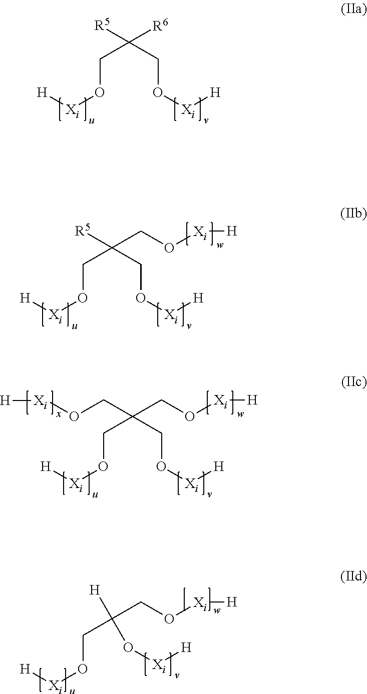

in which
R⁵ and R⁶ independently of one another are hydrogen or are C₁-C₁₈ alkyl optionally substituted by aryl, alkyl, aryloxy, alkyloxy, heteroatoms and/or heterocycles,
u, v, w, and x independently of one another are each an integer from 1 to 10, preferably 1 to 5, and more preferably 1 to 3, and
each Xᵢ, for i=1 to u, 1 to v, 1 to w, and 1 to x, may be selected independently of the others from the group —CH₂—CH₂—O—, —CH₂—CH(CH₃)—O—, —CH(CH₃)—CH₂—O—, —CH₂—C(CH₃)₂—O—, —C(CH₃)₂—CH₂—O—, —CH₂—CHVin-O—, —CHVin-CH₂—O—, —CH₂—CHPh-O—, and —CHPh-CH₂—O—, preferably from the group —CH₂—CH₂—O—, —CH₂—CH(CH₃)—O—, and —CH(CH₃)—CH₂—O—, and more preferably —CH₂—CH₂—O—,
in which Ph is phenyl and Vin is vinyl.

In these definitions, C₁-C₁₈ alkyl optionally substituted by aryl, alkyl, aryloxy, alkyloxy, heteroatoms and/or heterocycles is for example methyl, ethyl, propyl, isopropyl, n-butyl, sec-butyl, tert-butyl, pentyl, hexyl, heptyl, octyl, 2-ethylhexyl, 2,4,4-trimethylpentyl, decyl, dodecyl, tetradecyl, hexadecyl, octadecyl, 1,1-dimethylpropyl, 1,1-dimethylbutyl, 1,1,3,3-tetramethylbutyl, preferably methyl, ethyl or n-propyl, very preferably methyl or ethyl.

The (meth)acrylates in question are preferably (meth)acrylates of singly to vigintuply and with particular preference triply to decuply ethoxylated, propoxylated or mixedly ethoxylated and propoxylated, and more particularly exclusively ethoxylated, neopentyl glycol, trimethylolpropane, trimethylolethane or pentaerythritol.

Preferred polyfunctional polymerizable compounds are ethylene glycol diacrylate, 1,2-propanediol diacrylate, 1,3-propanediol diacrylate, 1,4-butanediol diacrylate, 1,6-hexanediol diacrylate, trimethylolpropane triacrylate, pentaerythritol tetraacrylate, polyesterpolyol acrylates, polyetherol acrylates, and triacrylate of singly to vigintuply alkoxylated, more preferably ethoxylated, trimethylolpropane.

Very particularly preferred polyfunctional polymerizable compounds are 1,4-butanediol diacrylate, 1,6-hexanediol diacrylate, trimethylolpropane triacrylate, pentaerythritol tetraacrylate, and triacrylate of singly to vigintuply ethoxylated trimethylolpropane.

In one preferred embodiment of the present invention the compound (Y) is at least one, preferably exactly one, urethane (meth)acrylate, more preferably a difunctional urethane (meth)acrylate having a weight-average molar weight Mw of below 1000 g/mol, preferably below 750, and more preferably below 500 g/mol.

These urethane (meth)acrylates are preferably reaction product of a (cyclo)aliphatic diisocyanate or polyisocyanate based on the oligomerization product of a (cyclo)aliphatic diisocyanate with at least one, preferably exactly one, compound having exactly one isocyanate-reactive group and exactly one free-radically polymerizable group.

The term “(cyclo)aliphatic diisocyanates” refers collectively to aliphatic and cycloaliphatic diisocyanates.

Cycloaliphatic isocyanates are those which comprise at least one cycloaliphatic ring system.

Aliphatic isocyanates are those which comprise exclusively linear or branched chains, in other words acyclic compounds.

The diisocyanates are preferably isocyanates having 4 to 20 C atoms.

Suitable (cyclo)aliphatic diisocyanates include hexamethylene diisocyanate, 1,3-bis(isocyanato-methyl)cyclohexane, isophorone diisocyanate, and 4,4′- or 2,4′-di(isocyanatocyclohexyl)-methane, preference is given to hexamethylene diisocyanate, isophorone diisocyanate and 4,4′- or 2,4′-di(isocyanatocyclohexyl)methane, and particular preference to hexamethylene diisocyanate and isophorone diisocyanate.

Examples of suitable compounds having exactly one isocyanate-reactive group and exactly one free-radically polymerizable group may for example be monoesters of α,β-unsaturated carboxylic acids, such as acrylic acid, methacrylic acid, crotonic acid, itaconic acid, fumaric acid, maleic acid, acrylamidoglycolic acid, methacrylamidoglycolic acid, or vinyl ethers, with diols which have preferably 2 to 20 C atoms and two hydroxyl groups. Examples of such diols are ethylene glycol, diethylene glycol, triethylene glycol, 1,2-propylene glycol, 1,3-propylene glycol, 1,1-dimethyl-1,2-ethanediol, dipropylene glycol, triethylene glycol, tetraethylene glycol, pentaethylene glycol, tripropylene glycol, 1,2-, 1,3- or 1,4-butanediol, 1,5-pentanediol, neopentyl glycol, 1,6-hexa-nediol, 2-methyl-1,5-pentanediol, 2-ethyl-1,4-butanediol, 1,4-dimethylolcyclohexane, 2,2-bis(4-hydroxycyclohexyl)propane, 2-ethyl-1,3-hexanediol, 2,4-diethyl-1,3-octanediol, 2,4-diethyl-1,5-octanediol or 2-propyl-1,3-heptanediol.

Compounds having exactly one isocyanate-reactive group and exactly one free-radically polymerizable group preferably 2-hydroxyethyl (meth)acrylate, 2- or 3-hydroxypropyl (meth)acrylate, 1,4-butanediol mono(meth)acrylate, neopentyl glycol mono(meth)acrylate, 1,5-pentanediol mono(meth)acrylate, and 1,6-hexanediol mono(meth)acrylate, more preferably 2-hydroxyethyl acrylate, 2-hydroxyethyl methacrylate, and 2-hydroxypropyl methacrylate, and very preferably 2-hydroxyethyl acrylate.

In a preferred embodiment compound (Y) can be water-dispersible. This can be achieved e.g. by introduction of components bearing at least one acid groups into a urethane (meth)acrylate.

Such suitable compounds having at least one isocyanate-reactive group and also at least one carboxylic acid or sulfonic acid group include, in particular, aliphatic monomercapto, mono-hydroxy, and monoamino and imino carboxylic acids and corresponding sulfonic acids, such as mercaptoacetic acid (thioglycolic acid), mercaptopropionic acid, mercaptosuccinic acid, hydroxyacetic acid, hydroxypropionic acid (lactic acid), hydroxysuccinic acid, hydroxypivalic acid, dimethylolpropionic acid, dimethylolbutyric acid, hydroxydecanoic acid, hydroxydode-canoic acid, 12-hydroxystearic acid, N-(2′-aminoethyl)-3-aminopropionic acid, hydroxyethane-sulfonic acid, hydroxypropanesulfonic acid, mercaptoethanesulfonic acid, mercaptopropan-esulfonic acid, aminoethanesulfonic acid, aminopropanesulfonic acid, glycine (aminoacetic acid), N-cyclohexylaminoethanesulfonic acid, N-cyclohexylaminopropanesulfonic acid, or iminodiacetic acid.

Preference is given to dimethylolpropionic acid and dimethylolbutyric acid, particular preference to dimethylolpropionic acid.

The acid groups can be neutralized partly or completely by organic and inorganic bases such as alkali metal and alkaline earth metal hydroxides, oxides, carbonates, and hydrogencarbonates, and also ammonia or primary, secondary or tertiary amines.

Epoxy (meth)acrylates are preferably obtainable by reacting epoxides with (meth)acrylic acid. Examples of suitable epoxides include epoxidized olefins, aromatic glycidyl ethers or aliphatic glycidyl ethers, preferably those of aromatic or aliphatic glycidyl ethers.

Examples of possible epoxidized olefins include ethylene oxide, propylene oxide, isobutylene oxide, 1-butene oxide, 2-butene oxide, vinyloxirane, styrene oxide or epichlorohydrin, preference being given to ethylene oxide, propylene oxide, isobutylene oxide, vinyloxirane, styrene oxide or epichlorohydrin, particular preference to ethylene oxide, propylene oxide or epichlorohydrin, and very particular preference to ethylene oxide and epichlorohydrin.

Aromatic glycidyl ethers are, for example, bisphenol A diglycidyl ether, bisphenol F diglycidyl ether, bisphenol B diglycidyl ether, bisphenol S diglycidyl ether, hydroquinone diglycidyl ether, alkylation products of phenol/dicyclopentadiene, e.g., 2,5-bis[(2,3-epoxypropoxy)phenyl]octa-hydro-4,7-methano-5H-indene (CAS No. [13446-85-0]), tris[4-(2,3-epoxypropoxyl)phenyl]-methane isomers (CAS No. [66072-39-7]), phenol-based epoxy novolaks (CAS No. [9003-35-4]), and cresol-based epoxy novolaks (CAS No. [37382-79-9]).

Preference is given to bisphenol A diglycidyl ether, bisphenol F diglycidyl ether, bisphenol B diglycidyl ether, and bisphenol S diglycidyl ether, and bisphenol A diglycidyl ether is particularly preferred.

Examples of aliphatic glycidyl ethers include 1,4-butanediol diglycidyl ether, 1,6-hexanediol diglycidyl ether, trimethylolpropane triglycidyl ether, pentaerythritol tetraglycidyl ether, 1,1,2,2-tetrakis[4-(2,3-epoxypropoxyl)phenyl]ethane (CAS No. [27043-37-4]), diglycidyl ether of polypropylene glycol (α,ω-bis(2,3-epoxypropoxy)poly(oxypropylene) (CAS No. [16096-30-3]) and of hydrogenated bisphenol A (2,2-bis[4-(2,3-epoxypropoxyl)cyclohexyl]propane, CAS No. [13410-58-7]).

Preference is given to 1,4-butanediol diglycidyl ether, 1,6-hexanediol diglycidyl ether, trimethylolpropane triglycidyl ether, pentaerythritol tetraglycidyl ether, and 2,2-bis[4-(2,3-epoxy-propoxy)cyclohexyl]propane.

The abovementioned aromatic glycidyl ethers are particularly preferred.

The epoxy (meth)acrylates and epoxy vinyl ethers preferably have a number-average molar weight Mₙ of 200 to 20 000, more preferably of 200 to 10 000 g/mol, and very preferably of 250 to 3000 g/mol; the amount of (meth)acrylic or vinyl ether groups is preferably 1 to 5, more preferably 2 to 4, per 1000 g of epoxy (meth)acrylate or vinyl ether epoxide (determined by gel permeation chromatography using polystyrene as standard and tetrahydrofuran as eluent).

Preferred epoxy (meth)acrylates have an OH number of 40 to 400 mg KOH/g.

Preferred epoxy (meth)acrylates have an average OH functionality of 1.5 to 4.5.

Particularly preferred epoxy (meth)acrylates are those such as are obtained from processes in accordance with EP-A-54 105, DE-A 33 16 593, EP-A 680 985, and EP-A-279 303, in which in a first stage a (meth)acrylic ester is prepared from (meth)acrylic acid and hydroxy compounds and in a second stage excess (meth)acrylic acid is reacted with epoxides.

Suitable polyester (meth)acrylates are at least partly or, preferably, completely (meth)acrylated reaction products of polyesterols.

Preferred polyesterols are those based on aliphatic, cycloaliphatic and/or aromatic dicarboxylic, tricarboxylic and polycarboxylic acids with diols, triols and/or polyols, and also lactone-based polyesterols.

Polyesterpolyols, are known, for example, from Ullmanns Encyklopädie der technischen Chemie, 4th edition, volume 19, pp. 62 to 65. Preference is given to using polyesterpolyols obtained by reaction of dihydric alcohols with dibasic carboxylic acids. Instead of the free polycarboxylic acids it is also possible to use the corresponding polycarboxylic anhydrides or corresponding polycarboxylic esters of lower alcohols or mixtures thereof to prepare the polyesterpolyols. The polycarboxylic acids may be aliphatic, cycloaliphatic, araliphatic, aromatic or heterocyclic, and if desired may be substituted, by halogen atoms, for example, and/or unsaturated. Examples thereof that may be mentioned include the following:

oxalic acid, maleic acid, fumaric acid, succinic acid, glutaric acid, adipic acid, sebacic acid, do-decanedioic acid, o-phthalic acid, isophthalic acid, terephthalic acid, trimellitic acid, azelaic acid, 1,4-cyclohexanedicarboxylic acid or tetrahydrophthalic acid, suberic acid, azelaic acid, phthalic anhydride, tetrahydrophthalic anhydride, hexahydrophthalic anhydride, tetrachlorophthalic anhydride, endomethylenetetrahydrophthalic anhydride, glutaric anhydride, maleic anhydride, di-meric fatty acids, their isomers and hydrogenation products, and their esterifiable derivatives, such as anhydrides or dialkyl esters, for example, C₁-C₄ alkyl esters, preferably methyl, ethyl or n-butyl esters, of the stated acids are employed. Dicarboxylic acids of general formula HOOC—(CH₂)_{y}—COOH are preferred, where y is a number from 1 to 20, preferably an even number from 2 to 20; particular preference is given to succinic acid, adipic acid, sebacic acid, and dodeca-nedicarboxylic acid.

Suitable polyhydric alcohols for preparing the polyesterols include 1,2-propanediol, ethylene glycol, 2,2-dimethyl-1,2-ethanediol, 1,3-propanediol, 1,2-butanediol, 1,3-butanediol, 1,4-butanediol, 3-methylpentane-1,5-diol, 2-ethylhexane-1,3-diol, 2,4-diethyloctane-1,3-diol, 1,6-hexanediol, poly-THF with a molar mass between 162 and 2000, poly-1,3-propanediol with a molar mass between 134 and 2000, poly-1,2-propanediol with a molar mass between 134 and 2000, polyethylene glycol with a molar mass between 106 and 2000, neopentylglycol, neopentylglycol hydroxypivalate, 2-ethyl-1,3-propanediol, 2-methyl-1,3-propanediol, 2,2-bis(4-hydroxycyclo-hexyl)propane, 1,1-, 1,2-, 1,3-, and 1,4-cyclohexanedimethanol, 1,2-, 1,3- or 1,4-cyclohexane-diol, trimethylolbutane, trimethylolpropane, trimethylolethane, neopentylglycol, pentaerythritol, glycerol, ditrimethylolpropane, dipentaerythritol, sorbitol, mannitol, diglycerol, threitol, erythritol, adonitol (ribitol), arabitol (lyxitol), xylitol, dulcitol (galactitol), maltitol or isomalt, which if desired may be alkoxylated as described above.

Preference is given to alcohols of the general formula HO—(CH₂)ₓ—OH, where x is a number from 1 to 20, preferably an even number from 2 to 20. Preferred are ethylene glycol, butane-1,4-diol, hexane-1,6-diol, octane-1,8-diol, and dodecane-1,12-diol. Additionally preferred is neopentylglycol.

Also suitable, furthermore, are polycarbonate-diols, of the kind obtainable, for example, by reacting phosgene with an excess of the low molecular weight alcohols stated as synthesis components for the polyesterpolyols.

Lactone-based polyesterdiols are also suitable, these being homopolymers or copolymers of lactones, preferably hydroxyl-terminated adducts of lactones with suitable difunctional starter molecules. Suitable lactones are preferably those deriving from compounds of the general formula HO—(CH₂)_{z}—COOH, where z is a number from 1 to 20, and where one H atom of a methylene unit may also have been substituted by a C₁ to C₄ alkyl radical. Examples are ε-caprolactone, β-propiolactone, gamma-butyrolactone and/or methyl-ε-caprolactone, 4-hydroxy-benzoic acid, 6-hydroxy-2-naphthoic acid or pivalolactone, and mixtures thereof. Examples of suitable starter components are the low molecular mass dihydric alcohols specified above as a synthesis component for the polyesterpolyols. The corresponding polymers of ε-caprolactone are particularly preferred. Lower polyesterdiols or polyetherdiols may also be used as starters for preparing the lactone polymers. Instead of the polymers of lactones it is also possible to use the corresponding, chemically equivalent polycondensates of the hydroxycarboxylic acids corresponding to the lactones.

Preferred polyesterols have a functionality in terms of free hydroxyl groups of at least 2, more preferably of 2 to 6, very preferably of 2 to 4, more particularly of 2 to 3, and especially of 2 exactly.

The molecular weights Mₙ of the polyesterols lie preferably between 500 and 4000 (Mₙ determined by gel permeation chromatography with polystyrene as standard and tetrahydrofuran as eluent).

The composition of the coating compositions of the invention is generally as follows:

(Z) 5% to 20%, preferably 7% to 15%, and more particularly 8% to 12%, by weight
components (A) to (E) 15% to 60%, preferably 20% to 50%, and more particularly 25% to 35%, by weight
(Y) 40% to 70% and preferably 35% to 65%, more preferably 40% to 65% by weight
with the proviso that the sum always amounts to 100% by weight.

Based on the sum of the compounds (A) to (E), (Y), and (Z), furthermore, the coating compositions of the invention may further comprise 0% to 10%, preferably 0.5 to 5% by weight of at least one photoinitiator (X).

Photoinitiators (X) may for example be photoinitiators known to the skilled worker, examples being those specified in “Advances in Polymer Science”, Volume 14, Springer Berlin 1974 or in K. K. Dietliker, Chemistry and Technology of UV and EB Formulation for Coatings, Inks and Paints, Volume 3; Photoinitiators for Free Radical and Cationic Polymerization, P. K. T. Oldring (Eds), SITA Technology Ltd, London.

Photoinitiators contemplated are those of the kind described in WO 2006/005491 A1, page 21, line 18 to page 22, line 2 (corresponding to US 2006/0009589 A1, paragraph[0150]), which is hereby incorporated by reference as part of the present disclosure.

Also suitable are nonyellowing or low-yellowing photoinitiators of the phenylglyoxalic ester type, as described in DE-A 198 26 712, DE-A 199 13 353 or WO 98/33761.

Preferred among these photoinitiators are 2,4,6-trimethylbenzoyldiphenylphosphine oxide, ethyl 2,4,6-trimethylbenzoylphenylphosphinate, bis(2,4,6-trimethylbenzoyl)phenylphosphine oxide, benzophenone, 1-benzoylcyclohexan-1-ol, 2-hydroxy-2,2-dimethylacetophenone, and 2,2-dimethoxy-2-phenylacetophenone.

Furthermore, based on the sum of the compounds (A) to (E), (Y), and (Z), the coating compositions of the invention may further comprise 0% to 10% by weight of further, typical coatings additives (G).

Examples of further typical coatings additives (G) that can be used include antioxidants, hindered amine and amine-oxide light stabilisers (HALS), activators (accelerants), fillers, pigments, dyes, antistats, flame retardants, thickeners, thixotropic agents, surface-active agents, viscosity modifiers, plasticizers or chelating agents.

In addition it is possible to add one or more thermally activable initiators, for example, potassium peroxodisulfate, dibenzoyl peroxide, cyclohexanone peroxide, di-tert-butyl peroxide, azobi-sisobutyronitrile, cyclohexylsulfonyl acetyl peroxide, diisopropyl percarbonate, tert-butyl peroc-toate or benzpinacol, and also, for example, those thermally activable initiators which have a half-life at 80° C. of more than 100 hours, such as di-tert-butyl peroxide, cumene hydroperoxide, dicumyl peroxide, tert-butyl perbenzoate, silylated pinacols, available commercially, for example, under the trade name ADDID 600 from Wacker.

Examples for hindered amine and amine-oxide light stabilisers (HALS) are hydroxyl-containing amine N-oxides, such as 2,2,6,6-tetramethylpiperidine-N-oxyl, 4-hydroxy-2,2,6,6-tetramethylpiperidine-N-oxyl, etc.

Further examples of suitable initiators are described in “Polymer Handbook”, 2nd ed., Wiley & Sons, New York.

Suitable thickeners, besides free-radically (co)polymerized (co)polymers, include typical organic and inorganic thickeners such as hydroxymethylcellulose or bentonite.

Chelating agents which can be used include, for example, ethylenediamineacetic acid and the salts thereof, and also β-diketones.

Suitable filers comprise silicates, examples being silicates obtainable by hydrolysis of silicon tetrachloride, such as Aerosil® from Evonik, siliceous earth, talc, aluminum silicates, magnesium silicates, calcium carbonates, etc.

The coating compositions of the invention are particularly suitable as coating material or in coating materials, more preferably for coating substrates such as wood, paper, textile, leather, nonwoven, plastics surfaces, glass, ceramic, mineral building materials, such as cement mold-ings and fiber-cement slabs, and, in particular, for coating of wood.

The coating compositions of the invention can be employed in particular in primers, wood stains, surfacers, pigmented topcoat materials and clearcoat materials, preferably primers and wood stains in the field of wood coating.

The coating compositions of the invention can be used with particular advantage for coating of wood and wood based materials (i.e. plywood, OSB, particleboards, such as MDF and HDF panels) and wood and/or vegetal fiber (i.e. hamp, sisal, jute etc. . . . ) containing substrates such as wood plastic composites (WPC). Also conceivable would be the coating of substrates containing cellulose fiber, such as paper, paperboard or cardboard, for example. With very particular preference the dispersions are suitable for the coating of oak, spruce, pine, beech, maple, walnut, macore, chestnut, plane, robinia, ash, birch, stone pine and elm, and also cork.

Coating of the substrates with the coating compositions of the invention takes place in accordance with typical processes known to the skilled worker, a coating composition of the invention or a paint formulation comprising it being applied in the desired thickness to the target substrate and optionally dried. This operation may if desired be repeated one or more times. Application to the substrate may take place in a known way, as for example by spraying, troweling, knifecoating, brushing, rolling, roller coating, pouring, laminating, injection backmolding or coextruding. The coating material may also be applied electrostatically in the form of powder (powder coating materials). The coating thickness is situated generally in a range from about 3 to 1000 g/m² and preferably 10 to 200 g/m².

Further disclosed is a method of coating substrates which involves applying to the substrate a coating composition of the invention or a paint formulation comprising it, optionally admixed with further, typical coatings additives and thermally, chemically or radiation-curable resins, optionally drying the applied coating, curing it with electron beams or UV exposure under an oxygen-containing atmosphere or, preferably, under inert gas, and optionally subjecting it to thermal treatment at temperatures up to the level of the drying temperature, and thereafter at temperatures up to 160° C., preferably between 60 and 160° C., more preferably between 100 and 160° C.

Radiation curing takes place with high-energy light, UV light for example, or electron beams. Radiation curing may take place at relatively high temperatures. Preference is given in that case to a temperature above the T_{g} of the radiation-curable binder.

Radiation curing here means the free-radical polymerization of polymerizable compounds as a result of electromagnetic and/or particulate radiation, preferably UV light in the wavelength range of λ=200 to 700 nm and/or electron radiation in the range from 150 to 300 keV, and more preferably with a radiation dose of at least 80, preferably 80 to 3000 mJ/cm².

Besides radiation curing there may also be further curing mechanisms involved, examples being thermal curing, moisture curing, chemical curing and/or oxidative curing, preferably thermal and radiation curing, and more preferably radiation curing alone.

The coating materials may be applied one or more times by any of a very wide variety of spraying methods, such as compressed-air, airless or electrostatic spraying methods, using one- or two-component spraying units, or else by injecting, troweling, knifecoating, brushing, rolling, roller coating, pouring, laminating, injection backmolding or coextruding.

The coating thickness is generally in a range from about 3 to 1000 g/m² and preferably 10 to 200 g/m².

Drying and curing of the coatings take place generally under standard temperature conditions, i.e., without the coating being heated. Alternatively the mixtures of the invention can be used to produce coatings which, following application, are dried and cured at an elevated temperature, e.g., at 40-250° C., preferably 40-150° C., and more particularly at 40 to 100° C. This is limited by the thermal stability of the substrate.

Additionally disclosed is a method of coating substrates which involves applying the coating composition of the invention or paint formulations comprising it, optionally admixed with thermally curable resins, to the substrate, drying it, and then curing it with electron beams or UV exposure under an oxygen-containing atmosphere or, preferably, under inert gas, optionally at temperatures up to the level of the drying temperature.

The method of coating substrates can also be practiced by irradiating the applied coating composition of the invention, or paint formulations, first with electron beams or UV exposure, under oxygen or, preferably, under inert gas, in order to obtain preliminary curing, then carrying out thermal treatment at temperatures up to 160° C., preferably between 60 and 160° C., and subsequently completely curing with electron beams or UV exposure under oxygen or, preferably, under inert gas.

If a plurality of layers of the coating material are applied one on top of another, drying and/or radiation curing may optionally take place after each coating operation.

Examples of suitable radiation sources for the radiation cure are low-pressure, medium-pressure, and high-pressure mercury lamps, and also fluorescent tubes, pulsed lamps, metal halide lamps, electronic flash devices, which allow radiation curing without a photoinitiator, or excimer lamps. The radiation cure is accomplished by exposure to high-energy radiation, i.e., UV radiation or daylight, preferably light emitted in the wavelength range of λ=200 to 700 nm, more preferably λ=200 to 500 nm, and very preferably λ=250 to 400 nm, or by irradiation with high-energy electrons (electron radiation; 150 to 300 keV). Examples of radiation sources used include high-pressure mercury vapor lamps, lasers, pulsed lamps (flash light), halogen lamps or excimer lamps. The radiation dose typically sufficient for crosslinking in the case of UV curing is situated in the range from 80 to 3000 mJ/cm².

It will be appreciated that it is also possible to use two or more radiation sources for the cure, two to four for example.

These sources may also each emit in different wavelength ranges.

Drying and/or thermal treatment may also take place, in addition to or instead of the thermal treatment, by means of NIR radiation, which here refers to electromagnetic radiation in the wavelength range from 760 nm to 2.5 μm, preferably from 900 to 1500 nm.

Irradiation can optionally also be carried out in the absence of oxygen, such as under an inert gas atmosphere. Suitable inert gases are preferably nitrogen, noble gases, carbon dioxide, or combustion gases. Furthermore, irradiation may take place with the coating composition being covered with transparent media. Examples of transparent media are polymeric films, glass or liquids, water for example. Particular preference is given to irradiation in the manner described in DE-A1 199 57 900.

It is an advantage of the present invention that, with the coating compositions of the invention, coatings are obtained which combine a high level of hardness with very good flexibility.

The examples below are intended to illustrate the present invention, but to do so without limiting it.

The % and ppm figures reported in this specification are % by weight and ppm by weight, un-less indicated otherwise.

1. A composition comprising at least one compound (Z), at least one UV absorber, and, optionally, at least one solvent (F),
where (Z) is 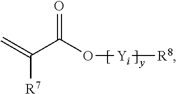
wherein,
R⁷ is selected from the group consisting of hydrogen and methyl,
R⁸ is C₁-C₂₀ alkyl,
n is a positive integer from 1 to 90, and
each Yᵢ for i=1 to y is, independently of the others, selected from the group consisting of —CH₂—CH₂—O—, —CH₂—CH(CH₃)—O—, —CH(CH₃)—CH₂—O—, —CH₂—C(CH₃)₂—O—, —C(CH₃)₂—CH₂—O—, —CH₂—CHVin-O—, —CHVin-CH₂—O—, —CH₂—CHPh-O—, and —CHPh-CH₂—O—, in which Ph is phenyl and Vin is vinyl, and
where the UV absorber is at least one selected from the group consisting of (4-phenyl) phenyl triazines (A), benzotriazoles (B), 2-hydroxyphenyl triazines, hydroxybenzophenones (D), and 3,3-diaryl-2-cyano propenoates (E).

2. The composition according to claim 1, wherein R⁷ is methyl.

3. The composition according to claim 1, wherein R⁶ is selected from the group consisting of methyl, ethyl, n-propyl, isopropyl and n-butyl.

4. The composition according to claim 1, wherein (Z) is a (meth)acrylic acid ester of monofunctional, alkyl-capped polyethylene glycols with an average molecular mass ranging from 100 to 4000 g/mol.

5. The composition according to claim 1 that comprises UV absorber (A), wherein (A) is a compound of formula I: 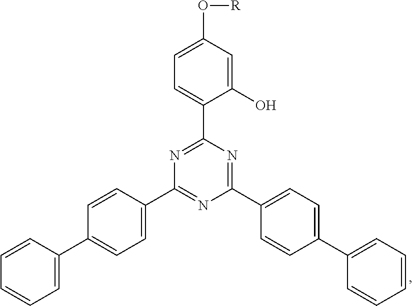
wherein R is (CH₂—CH₂—O—)ₙ—R₂; —CH₂—CH(OH)—CH₂—O—R₂; or —CH(R₃)—CO—O—R₄; n is 0 or 1; R₂ is C₁-C₁₃alkyl or C₂-C₂₀alkenyl or C₆-C₁₂aryl or CO—C₁-C₁₈alkyl; R₃ is H or C₁-C₈alkyl; R₄ is C₁-C₁₂alkyl or C₂-C₁₂alkenyl or C₅-C₆cycloalkyl.

6. The composition according to claim 1 that comprises UV absorber (B), wherein (B) is a benzotriazole of the formula 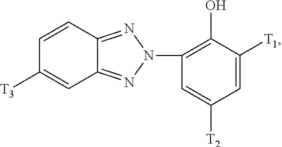
wherein T₁ is hydrogen, C₁-C₁₈alkyl, or C₁-C₁₈alkyl which is substituted by phenyl,
or T₁ is a group of the formula 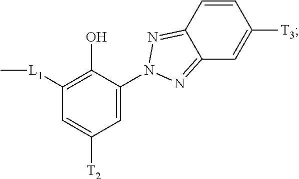
L₁ is —(CH₂)ₙ—, where n ranges from 1-8 or another divalent group;
T₂ is hydrogen, C₁-C₁₈alkyl, or is C₁-C₁₈alkyl which is substituted by COOT₅, C₁-C₁₈alkoxy, hydroxyl, phenyl or C₂-C₁₈acyloxy;
T₃ is hydrogen, halogen, C₁-C₁₈alkyl, C₁-C₁₈alkoxy, C₂-C₁₈acyloxy, perfluoroalkyl of 1 to 12 carbon atoms such as —CF₃, or T₃ is phenyl; and
T₅ is C₁-C₁₈alkyl or C₄-C₅₀alkyl interrupted by one or more O and/or substituted by OH or by a group

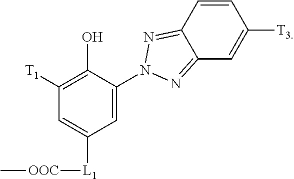

7. The composition according to claim 1 that comprises UV absorber (C), wherein (C) is a 2-hydroxyphenyltriazine of formula: 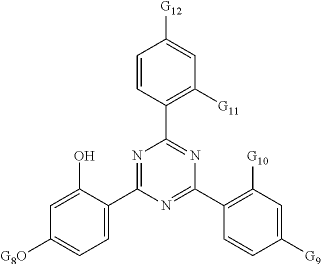
wherein
G₈ is C₁-C₁₈alkyl, or is C₄-C₁₈alkyl which is interrupted by COO or OCO or O, or is interrupted by O and substituted by OH;
G₉, G₁₀, G₁₁ and G₁₂ independently are hydrogen, methyl, hydroxy or OG₈.

8. The composition according to claim 1 that comprises UV absorber (D), wherein (D) is a 2-hydroxybenzophenone of formula: 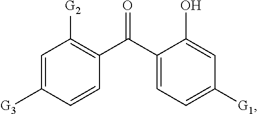
wherein G₁, G₂ and G₃ independently are hydrogen, hydroxy or C₁-C₁₈alkoxy.

9. The composition according to claim 1 that comprises UV absorber (E), wherein (E) is a 3,3-diaryl-2-cyano propenoates of the formula (E) 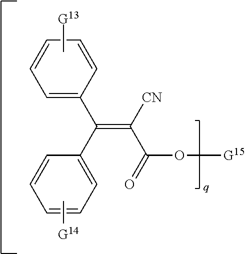
wherein
q is a positive integer from 1 to 4,
G¹³ and G¹⁴, independently are hydrogen, hydroxy, C₁-C₁₈ alkyl or C₁-C₁₈ alkoxy, and
G¹⁵ is a q-valent hydrocarbon with 1 to 10 carbon atoms.

10. The composition according to claim 1 consisting of:
(Z) 1% to 50% by weight,
components (A) to (E) 50% to 99% by weight,
with the proviso that the sum of (A)-(E) and (Z) amounts to 100% by weight.

11. A radiation-curable coating composition, comprising the composition according to claim 1 and further comprising:
at least one polyfunctional polymerizable compound (Y) having more than one (meth)acrylate group, and optionally,
at least one photoinitiator (X).

12. A radiation-curable coating composition according to claim 11, wherein compound (Y) is a urethane (meth)acrylate.

13. A radiation-curable coating composition according to claim 12, wherein the urethane (meth)acrylate (Y) is water dispersible.

14. A radiation-curable coating composition according to claim 11, comprising
(Z) 5% to 20% by weight,
components (A) to (E) 15% to 60% by weight,
(Y) 40% to 70% by weight,
with the proviso that the sum of (A)-(E), (Y) and (Z) amounts to 100% by weight.

15. A method for coating at least one kind of wood selected from the group consisting
of oak, spruce, pine, beech, maple, walnut, macore, chestnut, plane, robinia, ash, birch, stone pine and elm, and cork comprising treating said wood with the radiation-curable composition according to claim 11, and optionally, exposing the treated wood to radiation.

16. The composition according to claim 1, wherein n is a positive integer ranging from 10 to 20.

17. The composition according to claim 1, wherein each Yᵢ for i=1 to y is, independently of the others, selected from the group consisting of —CH₂—CH₂—O—, —CH₂—CH(CH₃)—O—, and —CH(CH₃)—CH₂—O.

18. The composition according to claim 1, wherein the UV absorber is at least one selected from the group consisting of (4-phenyl) phenyl triazines (A) and benzotriazoles (B).

19. The composition according to claim 1 that comprises solvent (F), wherein solvent (F) is at least one selected from the group consisting of water, alkanols, acetone, isobutyl methyl ketone, toluene, xylene, butyl acetate, methoxypropyl acetate and ethoxyethyl acetate.

20. A method for coating a substrate comprising treating said substrate with the composition according to claim 1 and, optionally, curing said composition.
